(19) United States
(12) Patent Application Publication
(10) Pub. No.: US 2024/0309673 A1
(43) Pub. Date: Sep. 19, 2024

(54) CARPORT TENT

(71) Applicant: ZHEJIANG ZHENGTE CO., LTD., Linhai (CN)

(72) Inventors: Patrick van Lierop, Linhai Zhejiang (CN); Younghui Chen, Linhai Zhejiang (CN)

(21) Appl. No.: 18/424,559

(22) Filed: Jan. 26, 2024

Related U.S. Application Data
(60) Provisional application No. 63/441,474, filed on Jan. 27, 2023.

(51) Int. Cl. E04H 15/44; E04H 15/54; E04H 15/64

(52) U.S. Cl. CPC E04H 15/44; E04H 15/64; E04H 15/54

(57) ABSTRACT

Disclosed are example embodiments of a Modular Carport Frame System. The Modular Carport Frame System includes a plurality of tubular components forming the structural framework. The Modular Carport Frame System also includes connectors for joining said tubular components, wherein the connectors include at least one 3-way connector and at least one 4-way connector, wherein the connectors feature both screw-in connections and snap-button joints. Additionally, the Modular Carport Frame System includes a securing mechanism for attaching a canopy to the frame.

### CROSS REFERENCE TO RELATED APPLICATIONS

The present application for patent claims priority to U.S. Provisional Patent Application No. 63/441,747 entitled “Carport Tent” filed Jan. 27, 2023, assigned to the assignee hereof and hereby expressly incorporated by reference herein.

### TECHNICAL FIELD

The disclosure relates generally to the field of modular structural systems, specifically and not by way of limitation, some embodiments are related to a modular carport frame system designed for ease of assembly, adaptability, and versatile use.

### BACKGROUND

Traditional carport and shelter structures often suffer from several limitations and drawbacks. These include a lack of versatility in design, making them suitable for only specific purposes such as vehicle storage. Many existing structures are not readily adaptable for other uses, such as gazebos, greenhouses, or boat shelters. Additionally, the assembly of conventional carports can be cumbersome, typically requiring specialized tools or professional installation. This complexity not only increases the time required for assembly but also limits the ability of users to modify or relocate the structure as needed.

Another significant limitation is the rigidity in the type of coverings that can be used. Most traditional carport structures are designed to support specific types of covers, such as metal sheets or certain fabrics, limiting their utility in various weather conditions or user preferences. The process of securing these coverings to the frame often lacks flexibility and may not provide a secure or lasting attachment, especially under adverse weather conditions.

Moreover, the connections used in conventional carport structures, such as permanent welding or complex mechanical fastenings, can make the disassembly or reconfiguration of the structure a challenging task. This inflexibility restricts the potential for reusing or repurposing the carport frames in different settings or for different needs.

Accordingly, a need exists for an improved carport structure.

### SUMMARY

Some embodiments may address the drawbacks of the prior art by providing a modular carport frame system that is versatile, easy to assemble, and adaptable for various uses. The system comprises a plurality of tubular components that form the structural framework, connectors for joining these components, and a securing mechanism for attaching a canopy to the frame. The connectors include at least one 3-way connector and at least one 4-way connector, featuring both screw-in connections and snap-button joints. This design allows for easy assembly and disassembly without specialized tools, offering significant flexibility and convenience to the user.

The modular nature of the frame system makes it adaptable for various structures beyond traditional carports, such as garages, sheds, gazebos, pergolas, barns, RV covers, boat shelters, bike shelters, greenhouses, and patio covers. This adaptability provides users with a single solution for multiple needs, reducing the necessity to purchase different structures for different applications.

Furthermore, the securing mechanism of the invention is designed to accommodate a variety of canopy materials, including tarps, polyethylene covers, canvas, and vinyl, among others. This flexibility allows users to select materials based on specific requirements such as weather conditions, usage, and personal preference, providing a customized shelter solution.

In summary, the modular carport frame system of the present invention offers significant improvements over traditional structures by providing versatility in use, ease of assembly and disassembly, and adaptability in terms of the type of coverings that may be used, some embodiments addressing the one or more limitations of the prior art.

Disclosed are example embodiments of a Modular Carport Frame System. The Modular Carport Frame System includes a plurality of tubular components forming the structural framework. The Modular Carport Frame System also includes connectors for joining said tubular components, wherein the connectors include at least one 3-way connector and at least one 4-way connector, wherein the connectors feature both screw-in connections and snap-button joints. Additionally, the Modular Carport Frame System includes a securing mechanism for attaching a canopy to the frame.

Disclosed are example embodiments of a method for assembling a carport frame. The method includes the steps of connecting a series of tubular components using a combination of screw-in connections and snap-button joints to form a frame and attaching a canopy material to the frame using an integrated securing device.

Disclosed are example embodiments of a Modular Carport Frame System. The Modular Carport Frame System includes means for forming a structural framework, said means comprising a plurality of tubular components. The Modular Carport Frame System also includes means for joining said tubular components, wherein said means include at least one 3-way connector and at least one 4-way connector, both featuring a combination of screw-in connections and snap-button joints, and means for securing a canopy to the frame, said means adaptable to accommodate various canopy materials.

The features and advantages described in the specification are not all-inclusive. In particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the disclosed subject matter.

### BRIEF DESCRIPTION OF THE DRAWINGS

The foregoing summary, as well as the following detailed description, is better understood when read in conjunction with the accompanying drawings. The accompanying drawings, which are incorporated herein and form part of the specification, illustrate a plurality of embodiments and, together with the description, further serve to explain the principles involved and to enable a person skilled in the relevant art(s) to make and use the disclosed technologies.

FIG. 1 is a diagram illustrating a carport frame in accordance with an embodiment of the instant application.

FIGS. 2A-2D are diagrams illustrating an example three-way connector of the carport frame of FIG. 1.

FIGS. 3A-3C are diagrams illustrating an example four-way connector of the carport frame of FIG. 1.

FIGS. 4A-4B are diagrams illustrating an example foot of the carport frame of FIG. 1.

FIG. 5 is a diagram illustrating a ring of the carport frame of FIG. 1.

FIG. 6 is a diagram illustrating the carport frame of the carport frame of FIG. 1 covered with canvas to form a carport.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The detailed description set forth below in connection with the appended drawings is intended as a description of configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of example systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using various components, hardware, electronic hardware, computer software, or any combination thereof. Whether such elements are implemented as hardware or software depends upon the particular application and design constraints imposed on the overall system.

Some embodiments may address the drawbacks of the prior art by providing a modular carport frame system that is versatile, easy to assemble, and adaptable for various uses. The system comprises a plurality of tubular components that form the structural framework, connectors for joining these components, and a securing mechanism for attaching a canopy to the frame. The connectors include at least one 3-way connector and at least one 4-way connector, featuring both screw-in connections and snap-button joints. This design may allow for easy assembly and disassembly without specialized tools, offering significant flexibility and convenience to the user.

The modular nature of the frame system makes it adaptable for various structures beyond traditional carports, such as garages, sheds, gazebos, pergolas, barns, RV covers, boat shelters, bike shelters, greenhouses, dog kennels, patio covers, and any other similar structures. This adaptability provides users with a single solution for multiple needs, reducing the necessity to purchase different structures for different applications.

Furthermore, the securing mechanism in some embodiments may be designed to accommodate a variety of canopy materials, including tarps, polyethylene covers, canvas, and vinyl, among others. This flexibility allows users to select materials based on specific requirements such as weather conditions, usage, and personal preference, providing a customized shelter solution.

In summary, some embodiments of the modular carport frame system may offer improvements over traditional structures by providing versatility in use, case of assembly and disassembly, and adaptability in terms of the type of coverings that can be used, addressing the key limitations of the prior art.

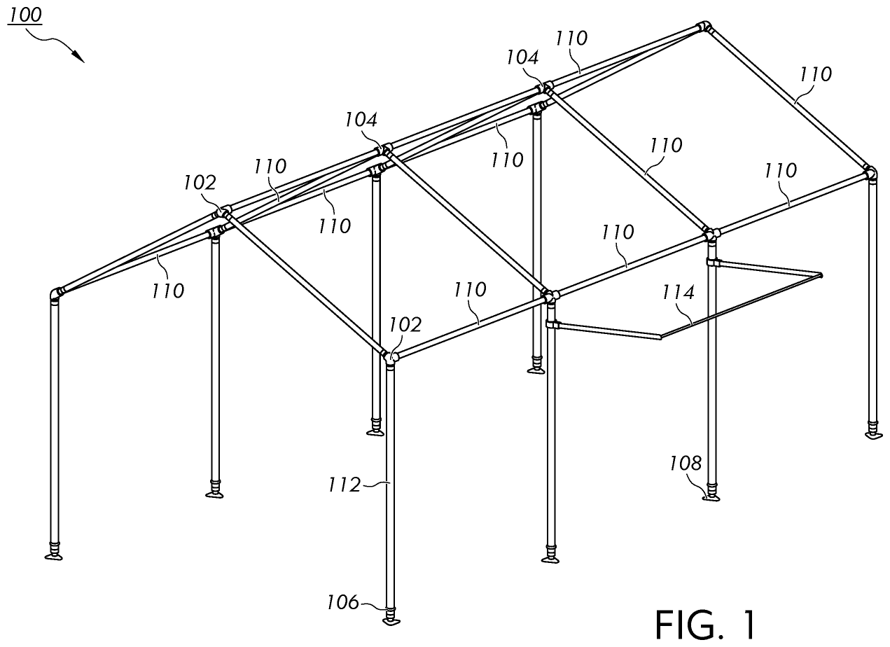

FIG. 1 is a diagram illustrating a carport frame 100 in accordance with an embodiment of the instant application. The carport frame 100 may provide a versatile and multifunctional structure. Its utility extends beyond traditional carports, encompassing a variety of other applications. This frame can be adapted for structures like garages, canopies, sheds, gazebos, pergolas, barns, car canopies, RV covers, boat shelters, bike shelters, greenhouses, and patio covers, making it a highly adaptable solution for various needs.

Carport frame 100 serves as a robust support system for different types of covers. Depending on the specific requirement, the canopy or cover could range from simple tarps to more sophisticated materials like polyethylene covers, canvas, vinyl, mesh fabric, waterproof cloth, heavy-duty plastic sheeting, sunshade fabric, PVC-coated material, ripstop nylon, acrylic fabric, insulated fabric panels, and reflective materials. This flexibility allows for customization based on weather conditions, usage, and aesthetic preferences.

The structural integrity of carport frame 100 is achieved through the assembly of pipes, tubes, conduits, or other tubular components. These elements are the backbone of the structure, providing the necessary strength and stability. The tubular components are interconnected using various connectors, enhancing the frame's versatility and adaptability. These connectors include, but are not limited to, components that facilitate 3-way connections (e.g., 3-way connector 103) and 4-way connections (e.g., 4-way connector 104), allowing for complex and diverse structural configurations.

In specific embodiments, the 3-way and 4-way connections incorporate both screw-in connections and “button lock” or “snap button” joints. For instance, the 3-way connection 102 could have two screw-in connections complemented by a “button lock” or “snap button” joint. Similarly, the 4-way connection 104 might feature two screw-in connections alongside two “button lock” or “snap button” joints. This combination of connection types provides a balance of stability and ease of assembly, making the structure both durable and user-friendly.

The “button lock” or “snap button” joints are particularly noteworthy for their efficiency and ease of use. They employ a spring-loaded button on a pipe that securely snaps into a corresponding hole or notch on another pipe or connector, such as the 3-way connector 102 or the 4-way connector 104. This mechanism ensures a quick and secure connection without necessitating additional tools, which is invaluable in structures requiring frequent adjustments or disassembly, like adjustable poles, tent frames, or other collapsible structures.

Further enhancing the functionality of carport frame 100, a ring 106 may be integrated into the foot tube. This ring serves as a clamp for a canopy hook, which is instrumental in securing the canopy to the frame. This feature ensures that the cover remains taut and secure, providing optimal protection against environmental elements.

The carport frame also includes a foot 108, which provides stable ground support. This is particularly important in ensuring the overall stability and safety of the structure, especially in outdoor environments. The frame's design includes a series of horizontal pipes (series 110) that connect the various connectors, and a series of vertical pipes (series 112), extending down to the foot 108. These vertical pipes may also include the ring 106, adding to the structural integrity and versatility of the carport frame 100.

In summary, carport frame 100 is a highly adaptable and efficient structure suitable for a wide range of applications. Its modular design, coupled with a variety of connection types and the ability to support various cover materials, makes it an ideal solution for numerous outdoor structures. Whether used as a simple carport or transformed into a more complex structure like a greenhouse or gazebo, its durability, case of assembly, and versatility make it a valuable asset in both residential and commercial settings.

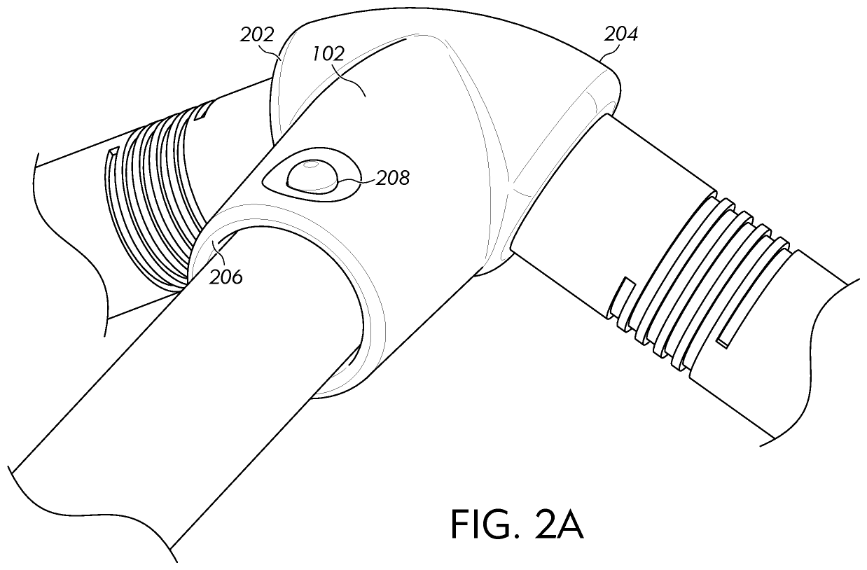

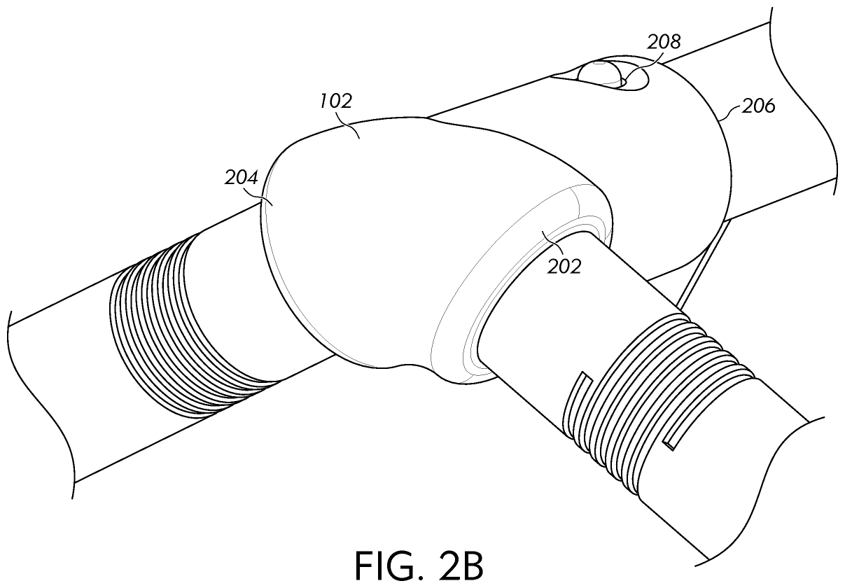

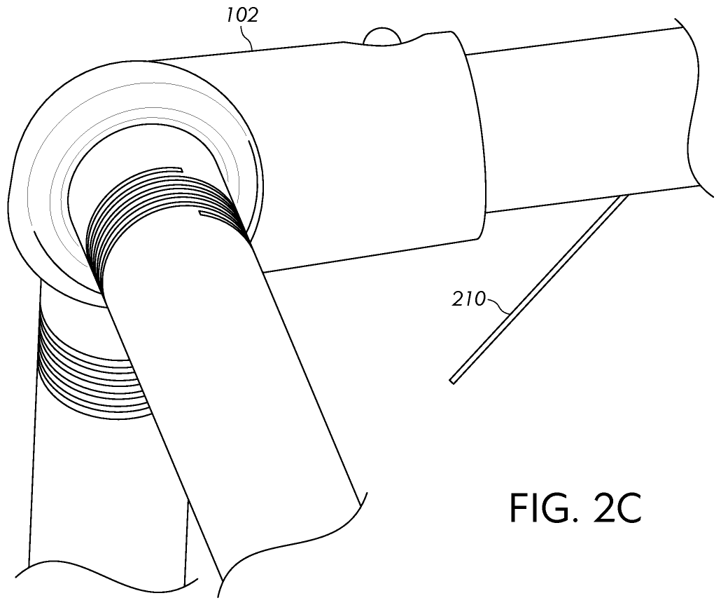

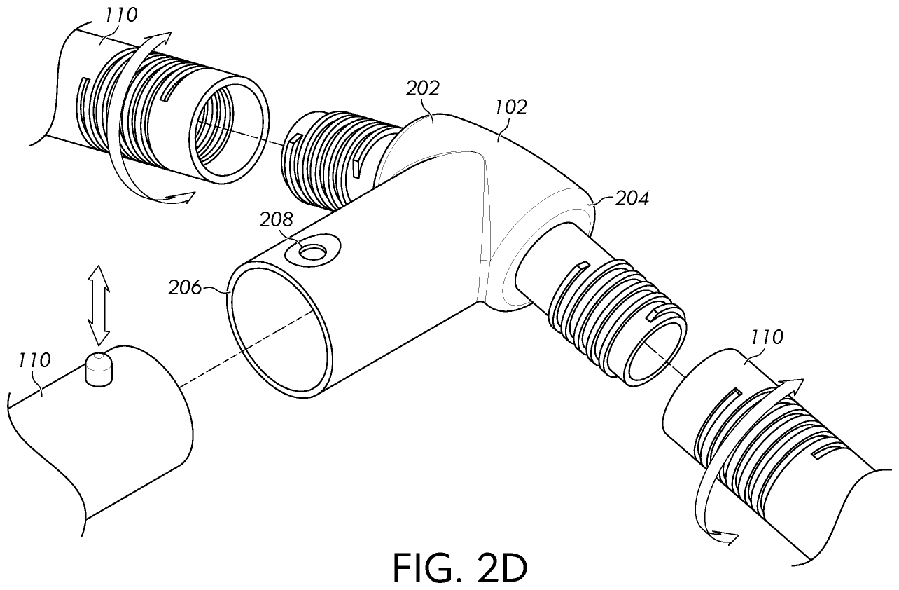

FIGS. 2A-2D are diagrams illustrating an example three-way connector 102 of the carport frame of FIG. 1. The three-way connector 102, may be one component of an example Modular Carport Frame System. This connector may be designed to facilitate the junction of three separate tubular components, forming a corner or T-junction in the frame structure.

The three-way connector 102 may be provided with three distinct openings 202, 204, 206, each engineered to accommodate the insertion of a tubular component. These openings may be oriented to allow for angular connection of the tubes, e.g., typically one opening 206 may be at 90 degrees to the other two openings 202, 204, although the connector may be adapted for other angles as per design requirements of a particular system. Openings 202, 204 may be angled relative to each other to form a roofline. The interior of each opening may be configured to snugly fit the outer diameter of the standard tubular components used in the carport frame system.

At least one of the openings 206 in the three-way connector 102 may be equipped with a snap-button joint mechanism. This feature may include a spring-loaded button that, when a tubular component is inserted, protrudes through a pre-designed hole in the tubular component, thereby locking it in place. This mechanism may, in some embodiments, ensure a secure and stable connection while allowing for easy assembly and disassembly.

At least one of the other openings 202, 204 in the connector may be designed for screw-in connections. These threaded interfaces allow for tubular components to be screwed into place, providing additional structural stability. The combination of snap-button and screw-in connections in the three-way connector 102 may offer both case of assembly and robustness in the overall structure. In one embodiment of in the three-way connector 102 one snap-button joint and two screw in connectors may be used, forming three connections.

Snap button connectors, e.g., having snap button 208, e.g., within a tube connecting to the snap button connector at an opening 206, may be a feature of some embodiments. The snap button connector may offer a simple yet effective solution for assembling and disassembling components. These connectors may include a pair of interlocking discs, one with a protruding button and the other with a corresponding hole or socket. The design may allow for easy and secure attachment: when the button is pressed into the socket, the edges of the socket flex slightly to accommodate the button 208 and then snap back, locking the button 208 in place. This mechanism may provide a firm hold while also allowing for quick release with a simple press or pull. Snap button connectors may be used in a wide range of applications and may provide for tool-free assembly, make them a popular choice in both industrial and consumer products. Snap button connectors may have a spring 210 that may be installed through a wall of a tube, as illustrated in FIG. 2C.

The three-way connector 102 may be typically manufactured from durable materials like high-strength plastics, metals, or alloys to ensure longevity and resistance to environmental factors such as weathering or corrosion. (A covering, e.g., canvas, forming the carport or other structure may also provide protection for the underlying frame.) The three-way connector 102 design may also include features like reinforcement ribs or flanges for added structural integrity.

Overall, FIG. 2A-2D's three-way connector 102 may form a part of the Modular Carport Frame System, contributing to the system's versatility, case of assembly, and structural robustness. The three-way connector 102's design may allow for the quick and secure joining of tubular components, facilitating the construction of a variety of structures as per the user's needs.

FIG. 2D provides an exploded view of the three-way connector 102, further illustrating its integration within the Modular Carport Frame System. The pipes 110 serve as a part of the frame. The pipes 110 are designed to integrate with the connector, enhancing the structural integrity of the carport. The pipes' role is to provide support and rigidity and couple to the connectors as illustrated in FIGS. 2A-2D, ensuring a stable and durable construction. The pipes 110 may be made from materials that complement the three-way connector, such as high-strength metals or alloys, to withstand various environmental stresses. The exploded view in FIG. 2D offers a clearer understanding of the individual components and their assembly and may also underscores the system's modular nature, showcasing how each part contributes to the easy assembly and robustness of the overall structure.

In FIG. 2D, the three-way connector 102 is illustrated with two of its openings designed for screw-on connections to threaded parts extending from the three-way connector 102, providing a firm and secure attachment of the pipes. The third opening incorporates a snap-button joint mechanism, allowing for quick and easy assembly while ensuring a stable connection and another way to connect one or more pipes 110 to the three-way connector 102. Additionally, in another embodiment, the design may be altered so that the pipe screws directly into the three-way connector, e.g., there may be threads internal to two parts of the three-way connector, such that pipes 110 screw into the connector rather than fitting over extensions from the connector 102, offering an alternative method of assembly that further enhances the structural integrity and versatility of the Modular Carport Frame System. In such an example, the third connection may still be a snap-button joint mechanism, allowing for quick and easy assembly while ensuring a stable connection and another way to connect one or more pipes 110 to another example the three-way connector.

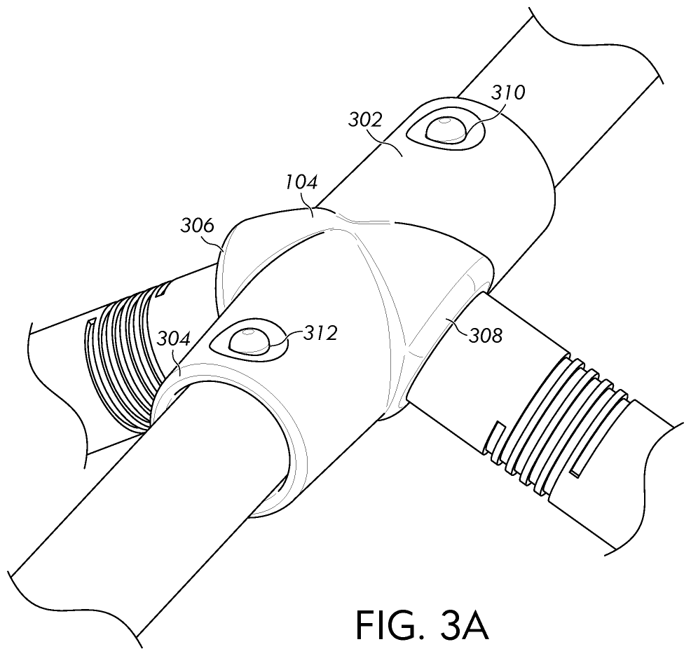

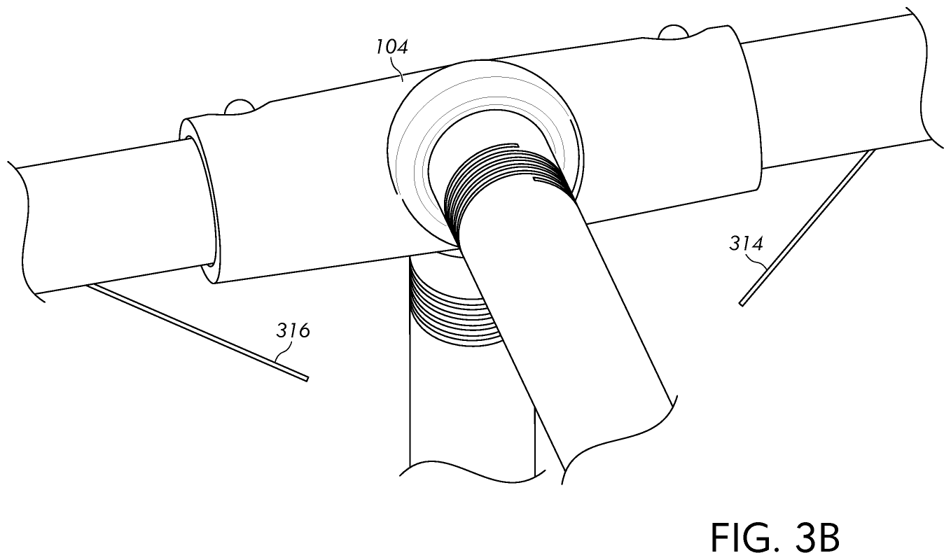

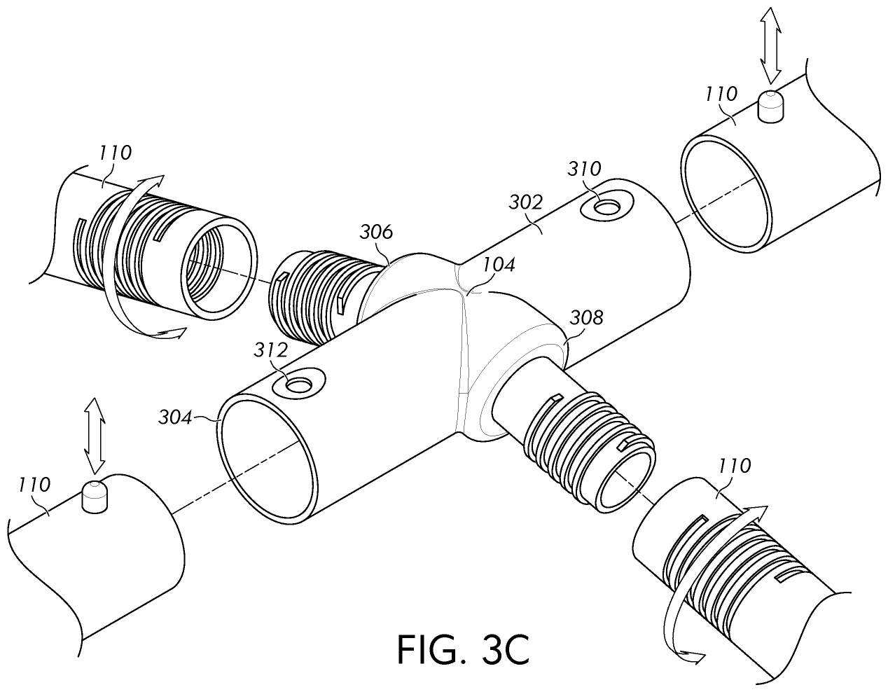

FIGS. 3A-3C are diagrams illustrating an example four-way connector 104 of the carport frame of FIG. 1, including exploded view FIG. 3C. The four-way connector 104 may be another element of the Modular Carport Frame System. The four-way connector 104 may be specifically designed for connecting four tubular components, forming a secure and stable junction within the carport frame structure.

The design of the four-way connector 104 may provide a body with four openings 302, 304, 306, 308, each intended to accommodate the insertion of a tubular component. These openings may be positioned to facilitate the formation of a four-way intersection of tubular components. The openings of the four-way connector 104 may typically be at right angles, but the four-way connector 104 may be adapted to different angular configurations depending on the specific design requirements of the carport frame. For example, openings 306, 308 may be angled relative to each other to form a roofline.

Each opening in the four-way connector 104, like the three-way connector 102, may be dimensioned to match the outer diameter of the tubular components the four-way connector 104 is designed to receive to from the carport frame, ensuring a fit that may be one or more of tight and secure. The connector may incorporate a combination of connection mechanisms to enhance the stability and durability of the assembled structure. The three-way connector 102 and the four-way connector 104 may be designed to receive one or more sizes of tubular components, e.g., a different size tubular component in one or more of the three (or four) openings.

One feature of the four-way connector 104 is the four-way connector 104's snap-button joint mechanism, which fits into at least one of the openings. This mechanism may include a spring-loaded button 310, 312 that, upon the insertion of a tubular component, engages with a corresponding hole in the tube, thereby locking the tube securely in place. This snap-button joint may allow for quick and tool-free assembly while ensuring a strong and reliable connection. One example spring 314, 316 is illustrated in FIG. 3B.

The other openings in the four-way connector 104 may include one or more screw-in connections. These connections may involve threaded interfaces that enable the tubular components to be securely screwed into the connector. The use of both snap-button and screw-in connections in the four-way connector 104 offers a balance of easy assembly and structural integrity. The illustrated example of FIG. 3 includes two snap-button and two screw-in connections.

In some example embodiments, constructed from high-strength materials such as durable plastics, metals, or alloys, the three-way connector 104 may provide for a device that may withstand various environmental conditions, including exposure to weather elements and mechanical stress. Additional design features like reinforcement ribs or flanges may be included to further enhance the connector's structural strength.

In summary, FIG. 3's depiction of the four-way connector 104 illustrates the connector's role in the Modular Carport Frame System. The four-way connector 104 enables the efficient and secure assembly of tubular components, contributing to the versatility and adaptability of the system for various applications, from simple carports to more complex structures like greenhouses or gazebos.

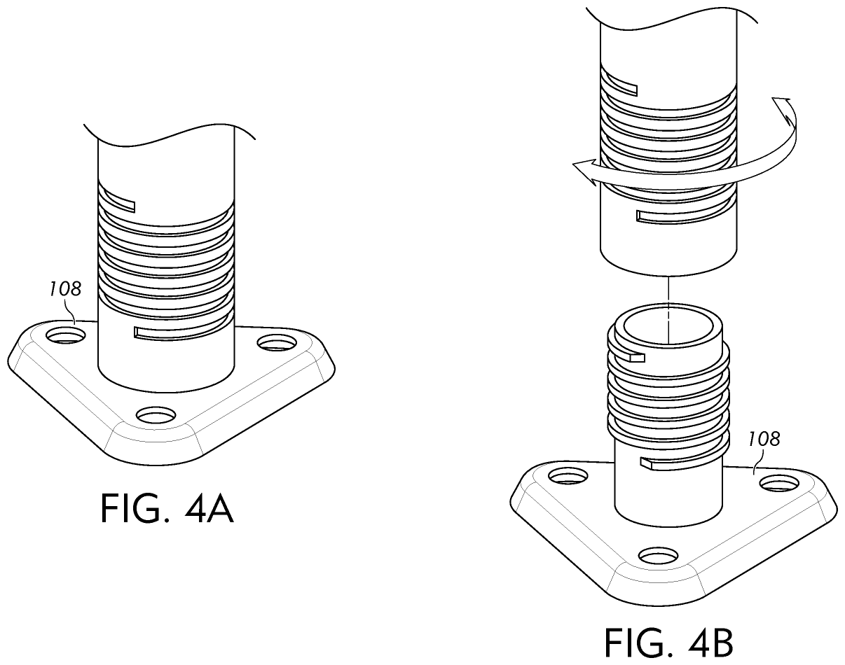

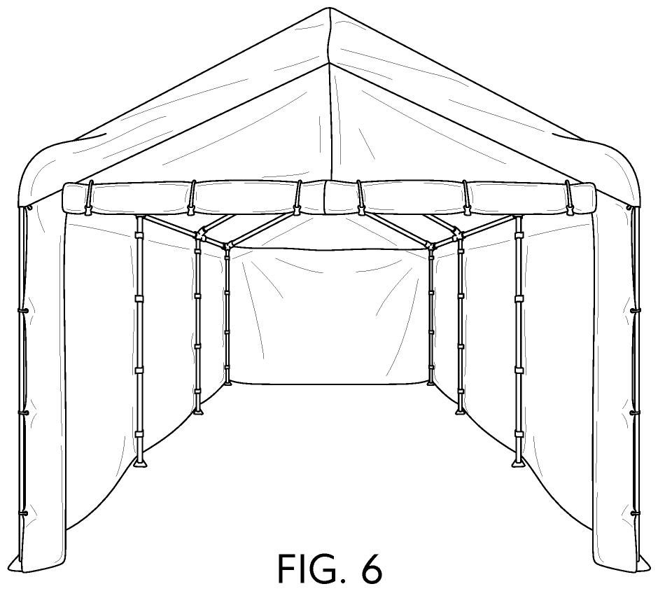

FIGS. 4A-4B are diagrams illustrating an example foot 108 of the carport frame of FIG. 1. FIG. 4B is an exploded view. The foot 108 of the carport frame 100, as described herein, may be a component that plays a role in the overall functionality and stability of the carport structure. Also included in some example embodiments, the integration of a ring 106 (FIG. 6) on the tube, including the foot 108. In some examples, the ring may be an integral part of the foot structure and may function is to serve as a clamp for a canopy hook, a feature that is instrumental in securing the canopy to the frame.

The foot 108 may provide stable ground support that may ensure the overall stability and safety of the carport. This is particularly important in outdoor environments where the carport must withstand varying ground conditions and weather elements. The stability offered by the foot connection may provide for the carport's structural integrity and the safety of the users, as well as for the protection of vehicles or other items stored under the carport.

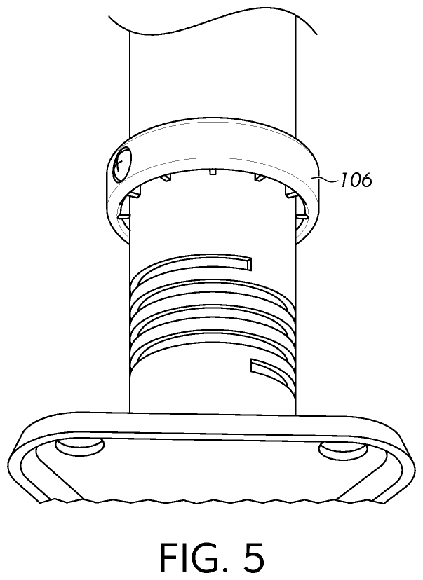

FIG. 5 depicts ring 106, a specialized component of the Modular Carport Frame System. This ring plays a role in the system, primarily serving as an attachment point for securing canopy materials to the frame. The ring 106 is illustrated as a circular, robust component designed to be integrated into or attached to one of the tubular components of the carport frame and may be an integrated assembly with the foot 108, in some embodiments. In other embodiments, the foot 108 and the ring 106 may be separate components coupled together by a tube. The ring's primary function, in some embodiments, may be to provide a secure and convenient point for attaching canopy hooks or clasps, which are used to hold the canopy material (such as tarps, polyethylene covers, canvas, or vinyl) in place against the frame.

The design of ring 106 may be such that the ring 106 may accommodate a range of hook or clasp sizes, making it versatile for various types of canopy materials and attachment methods. This adaptability is essential for ensuring that the canopy remains taut and secure, providing optimal protection and stability, especially in outdoor environments where wind and weather can exert force on the structure.

In terms of material, ring 106 may typically be made from a durable material capable of withstanding significant stress and environmental exposure. Materials like high-strength steel, aluminum, or reinforced plastics are common choices, offering a combination of durability, resistance to corrosion, and lightweight properties.

The ring 106 may feature a smooth, rounded design to prevent any wear and tear on the canopy material and to ensure ease of attachment and detachment of the hooks or clasps. Additionally, the ring 106 may be designed to rotate or swivel, providing flexibility in the positioning of the canopy and facilitating easy adjustment.

Overall, FIG. 5's representation of the ring 106 illustrates one example of the ring 106 in the Modular Carport Frame System. The ring 106 provides a solution for securely attaching canopy materials to the frame, contributing to the overall functionality and utility of the carport or other structures built using the system. The ring's design and material choice are geared towards ensuring longevity, ease of use, and versatility, aligning with the system's goal of providing a practical and adaptable shelter solution.

FIG. 6 is a diagram illustrating the carport frame of FIG. 1 covered with canvas to form a carport. The frame 100 is now covered with a canvas to form a carport. This diagram demonstrates how the carport frame may be utilized in some examples, as the structural foundation upon which the canvas may be laid, showcasing the transition from a mere frame to a fully functional carport. The canvas covering, draped over the frame, may transform the skeletal structure into a practical shelter, providing a clear visual representation of the carport in one example intended use.

In an embodiment of the Modular Carport Frame System, the structure incorporates a selection of tubular components. These components, which may be made from various materials such as pipes, tubes, or conduits, provide flexibility in adapting the system to different requirements or environmental conditions.

The assembly of these components is facilitated by connectors, which may include a combination of 3-way and 4-way connectors. These connectors are designed to accommodate both screw-in connections and snap-button joints. The inclusion of snap-button joints, possibly with a spring-loaded button mechanism, allows for a more straightforward assembly and disassembly process, enhancing the overall convenience of the system.

The system might also feature a ring integrated into one or more of the tubular components. This ring is intended for securing canopy hooks, which could assist in attaching a canopy to the frame effectively. The canopy, essential for providing shelter, could be made from various materials like tarps, polyethylene covers, canvas, or vinyl, depending on specific needs such as weather conditions and usage.

For added stability, particularly in outdoor settings, a foot connection could be included at the base of the frame. This element may enhance the structural integrity and safety of the carport.

The adaptability of the frame is another potential aspect of its design. It may be suitable for constructing a variety of structures, including but not limited to garages, sheds, gazebos, pergolas, barns, and various types of shelters like RV covers, boat shelters, bike shelters, greenhouses, and patio covers.

In a methodological embodiment for assembling a carport frame, the process might involve connecting the series of tubular components using the aforementioned connectors. The adaptability of the frame could allow for rearranging the components to form various structures, demonstrating the system's versatility.

Thus, the Modular Carport Frame System, in its various embodiments, may offer a practical, adaptable, and user-friendly solution suitable for a wide array of applications.

In a generalized description that encompasses the concept of an “n-way” connector within the Modular Carport Frame System, the invention can include connectors that facilitate the joining of multiple tubular components at a single junction point. Although the specific examples in the patent description illustrate three-way (102) and four-way (104) connectors, the concept can be extended to an “n-way” connector, where “n” represents any number of connections.

An “n-way” connector is a versatile component designed to accommodate “n” number of tubular components. Each connector features multiple openings, each configured to snugly fit a tubular component. The orientation and angle of these openings can vary based on the specific requirements of the carport's design, enabling the construction of complex structures with varying angles and junctions.

In some embodiments, such as those shown in FIGS. 2 and 3, the connectors are three-way and four-way connectors. However, the principle can be applied to connectors with more than four connections, allowing for even more complex and versatile frame designs. These connectors could be used to construct various structures, ranging from simple carports to more complex frameworks like greenhouses or pergolas.

Each opening in an “n-way” connector could be equipped with different types of connection mechanisms, such as snap-button joints or screw-in connections. Snap-button joints, possibly featuring spring-loaded buttons, offer ease of assembly and secure locking of the tubular components. Screw-in connections provide additional structural stability and robustness to the assembled structure.

The design and material of the “n-way” connectors are crucial for ensuring durability and resistance to environmental factors. They may be manufactured from high-strength materials such as plastics, metals, or alloys and might include additional features like reinforcement ribs or flanges for added structural integrity.

In summary, the concept of an “n-way” connector in the Modular Carport Frame System introduces a level of modularity and flexibility, enabling the construction of a wide range of structures tailored to specific needs and applications. The versatility of these connectors, as demonstrated in the specific examples of three-way and four-way connectors, highlights the system's adaptability and ease of assembly.

One or more elements or aspects or steps, or any portion(s) thereof, from one or more of any of the systems and methods described herein may be combined with one or more elements or aspects or steps, or any portion(s) thereof, from one or more of any of the other systems and methods described herein and combinations thereof, to form one or more additional implementations and/or claims of the present disclosure.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A Modular Carport Frame System, comprising:
a plurality of tubular components forming the structural framework;
connectors for joining said tubular components, wherein the connectors include at least one 3-way connector and at least one 4-way connector, wherein the connectors feature both screw-in connections and snap-button joints; and
a securing mechanism for attaching a canopy to the frame.

2. The Modular Carport Frame System of claim 1, wherein the tubular components comprise at least one of pipes, tubes, and conduits.

3. The Modular Carport Frame System of claim 1, wherein the snap-button joints include a spring-loaded button mechanism for easy assembly and disassembly.

4. The Modular Carport Frame System of claim 1, further comprising a ring integrated into at least one of the tubular components for securing canopy hooks.

5. The Modular Carport Frame System of claim 1, further comprising a foot connection at the base of the frame for ground support.

6. The Modular Carport Frame System of claim 1, wherein the frame is adaptable for various structures including at least one of a garage, shed, gazebo, pergola, barn, RV cover, boat shelter, bike shelter, greenhouse, and patio cover.

7. The Modular Carport Frame System of claim 1, wherein the canopy material is selected based on specific requirements including weather conditions and usage.

8. The Modular Carport Frame System of claim 1, wherein the securing mechanism including at least one of clamps, hooks.

9. The Modular Carport Frame System of claim 1, further comprising the canopy, wherein the canopy comprises at least one of materials such as tarps, polyethylene covers, canvas, and vinyl.

10. A method for assembling a carport frame, comprising the steps of:
connecting a series of tubular components using a combination of screw-in connections and snap-button joints to form a frame;
attaching a canopy material to the frame using an integrated securing device.

11. The method of claim 10, wherein the frame is adaptable to form different structures by rearranging the tubular components and connectors.

12. The method of claim 10, wherein the tubular components comprise at least one of pipes, tubes, and conduits.

13. The method of claim 10, wherein the snap-button joints employed in connecting the series of tubular components include a spring-loaded button mechanism.

14. The method of claim 10, further comprising the step of integrating a ring into at least one of the tubular components to facilitate securing of the canopy hooks.

15. The method of claim 10, further comprising the step of attaching a foot connection at the base of the frame for ground support.

16. The method of claim 10, wherein the canopy material attached to the frame is selected based on specific requirements including weather conditions and usage, and comprises at least one of materials such as tarps, polyethylene covers, canvas, and vinyl.

17. The method of claim 10, further comprising the step of adapting the frame to form various structures including at least one of a garage, shed, gazebo, pergola, barn, RV cover, boat shelter, bike shelter, greenhouse, and patio cover by rearranging the tubular components and connectors.

18. A Modular Carport Frame System, comprising:
means for forming a structural framework, said means comprising a plurality of tubular components;
means for joining said tubular components, wherein said means include at least one 3-way connector and at least one 4-way connector, both featuring a combination of screw-in connections and snap-button joints; and
means for securing a canopy to the frame, said means adaptable to accommodate various canopy materials.

19. The Modular Carport Frame System of claim 18, wherein the means for forming a structural framework are further defined as means comprising tubular components selected from at least one of pipes, tubes, and conduits.

20. The Modular Carport Frame System of claim 1, wherein the means for joining said tubular components include a snap-button joint mechanism, said mechanism functioning as a means for easy assembly and disassembly through a spring-loaded button mechanism.
